(19) United States
(12) Patent Application Publication
(10) Pub. No.: US 2014/0127991 A1
(43) Pub. Date: May 8, 2014

(54) METHOD FOR PERFORMING COMMUNICATION BETWEEN DEVICES IN A WIRELESS ACCESS SYSTEM, AND DEVICE FOR SAME

(71) Applicants: Dongguk Lim, Anyang-si (KR); Jiwoong Jang, Anyang-si (KR); Hangyu Cho, Anyang-si (KR)

(72) Inventors: Dongguk Lim, Anyang-si (KR); Jiwoong Jang, Anyang-si (KR); Hangyu Cho, Anyang-si (KR)

(73) Assignee: LG ELECTRONICS INC., Seoul (KR)

(21) Appl. No.: 14/125,541

(22) PCT Filed: Jun. 8, 2012
(86) PCT No.: PCT/KR2012/004528

§ 371 Date: Dec. 11, 2013

Related U.S. Application Data
(60) Provisional application No. 61/499,667, filed on Jun. 21, 2011.

(51) Int. Cl. H04W 76/02

(52) U.S. Cl. CPC H04W 76/023
USPC 455/39

(57) ABSTRACT

Disclosed are a method for performing communication between devices in a wireless access system supporting device-to-device communication, and a device for same. More particularly, the method comprises the steps of: transmitting, from a first device to a base station, instruction information on whether or not device-to-device communication is supported by the first device; receiving, by the first device, group information for grouping devices which support device-to-device communication, from the base station using mobility information and position information on the devices supporting device-to-device communication; selecting, by the first device using the group information, a second device that is to perform device-to-device communication between devices; and performing device-to-device communication with the second device selected by the first device.

### TECHNICAL FIELD

The present invention relates to a wireless access system, and more particularly, to a method for performing communication between devices in a wireless access system supporting device-to-device (D2D) communication and a device for the same.

### BACKGROUND ART

In cellular communication, a UE in a cell accesses a base station (BS) to receive control information for transmitting/receiving data to/from the BS and then transmits/receives the data to perform communication. That is, since the UE transmits/receives data through the BS, the UE transmits data thereof to the BS in order to transmit the data to another cellular UE such that the BS delivers the data received from the UE to the other UE. Since the UE can transmit data to another UE only through the BS in this manner, the BS schedules channels and resources for data transmission and reception and transmits channel and resource scheduling information to each UE. To perform communication between UEs through the BS, each UE requires channel and resource allocation for data transmission/reception to/from the BS. However, D2D communication directly transmits/receives a signal to/from a UE that wants to transmit data without a BS or a relay.

### DISCLOSURE

### Technical Problem

An object of the present invention devised to solve the problem lies in a method for performing communication between devices in a wireless access system, preferably a wireless access system supporting D2D communication and a device for the same.

Another object of the present invention is to provide a method for efficiently searching for or selecting a device for performing D2D communication and a device for the same.

The technical problems solved by the present invention are not limited to the above technical problems and those skilled in the art may understand other technical problems from the following description.

### Technical Solution

The object of the present invention can be achieved by providing a method for performing communication between devices in a wireless access system supporting device-to-device communication (D2D), the method including: a first device transmitting, to a base station (BS), information indicating whether or not the first device supports D2D communication; the first device receiving, from the BS, group information on grouping of devices supporting D2D communication using mobility information and position information on the devices; the first device selecting a second device attempting to perform D2D communication using the group information; and the first device performing D2D communication with the selected second device.

In another aspect of the present invention, provided herein is a device for performing communication between devices in a wireless access system supporting D2D, the device including: a radio frequency (RF) unit for transmitting/receiving a radio signal; and a processor configured to transmit, to a BS, information indicating whether or not the device supports D2D communication, to receive, from the BS, group information on grouping of devices supporting D2D communication using mobility information and position information on the devices, to select a second device attempting to perform D2D communication using the group information and to perform D2D communication with the selected second device.

The first device may transmit the indication information during a network access process.

The first device may transmit the indication information before mode change to an idle mode or a sleep mode.

The first device may transmit an Internet protocol (IP) addresses allocated thereto along with the indication information.

The first device may transmit, to the second device, a measurement signal for measuring a channel state between the first device and the second device, receive, from the second device, channel state information obtained by measuring the channel state using the measurement signal and determine whether to perform D2D communication with the second device on the basis of the channel state information.

The first device may retransmit the measurement signal to the second device when the first device does not receive the channel state information from the second device within a predetermined time or receives a message requesting retransmission of the measurement signal from the second device.

The first device may reselect a device attempting to perform D2D communication using the group information when the first device repeats retransmission of the measurement signal a predetermined number of times or more.

The first device may transmit a message requesting update of the group information to the BS when the first device repeats retransmission of the measurement signal a predetermined number of times or more.

### Advantageous Effects

According to embodiments of the present invention, it is possible to provide a method for performing D2D communication in a wireless access system, preferably, a wireless communication system supporting D2D communication, thereby achieving efficient communication environments.

In addition, according to the embodiments of the present invention, it is possible to efficiently search for or select a device for performing D2D communication by grouping devices using mobility information and position information on devices supporting D2D communication.

The effects of the present invention are not limited to the above-described effects and other effects which are not described herein will become apparent to those skilled in the art from the following description.

### DESCRIPTION OF DRAWINGS

The accompanying drawings, which are included to provide a further understanding of the invention, illustrate embodiments of the invention and together with the description serve to explain the principle of the invention. In the drawings:

FIG. 1 illustrates a method of signaling, to a BS, whether or not a device supports D2D communication according to an embodiment of the present invention;

FIG. 2 illustrates a method of signaling, to a BS, whether or not a device supports D2D communication according to an embodiment of the present invention;

FIG. 3 illustrates allocation of an IP address to a device according to an embodiment of the present invention;

FIG. 4 illustrates a method for performing D2D communication according to an embodiment of the present invention;

FIG. 5 illustrates a method for performing D2D communication according to an embodiment of the present invention;

FIG. 6 illustrates a method for performing D2D communication according to an embodiment of the present invention;

FIG. 7 illustrates a method for performing D2D communication according to an embodiment of the present invention;

FIG. 8 illustrates a method for performing D2D communication according to an embodiment of the present invention;

FIG. 9 illustrates a method for performing D2D communication according to an embodiment of the present invention; and

FIG. 10 is a block diagram of a wireless communication device according to an embodiment of the present invention.

### BEST MODE

Preferred embodiments of the present invention will be described in detail with reference to the accompanying drawings. However, the present invention is not limited to the embodiments illustrated hereinafter, and the embodiments herein are rather introduced to provide an easy and complete understanding of the scope and spirit of the present invention.

In some cases, to prevent the concept of the present invention from being ambiguous, structures and apparatuses of the known art will be omitted, or will be shown in the form of a block diagram based on main functions of each structure and apparatus.

In the embodiments of the present invention, a description is made, centering on a data transmission and reception relationship between a base station (BS) and a user equipment (UE). The BS is a terminal node of a network, which communicates directly with a UE. In some cases, a specific operation described as performed by the BS may be performed by an upper node of the BS. Namely, it is apparent that, in a network comprised of a plurality of network nodes including a BS, various operations performed for communication with a UE may be performed by the BS, or network nodes other than the BS. The term ‘BS’ may be replaced with the term ‘fixed station’, ‘Node B’, ‘evolved Node B (eNode B or eNB)’, ‘access point (AP)’, etc. The term ‘UE’ may be replaced with the term ‘terminal’, ‘mobile station (MS)’, ‘mobile subscriber station (MSS)’, ‘subscriber station (SS)’, etc.

Specific terms used for the embodiments of the present invention are provided to help the understanding of the present invention. These specific terms may be replaced with other terms within the scope and spirit of the present invention.

The embodiments of the present invention can be supported by standard documents disclosed for at least one of wireless access systems, Institute of Electrical and Electronics Engineers (IEEE) 802, 3^{rd} Generation Partnership Project (3GPP), 3GPP Long Term Evolution (3GPP LTE), LTE-Advanced (LTE-A), and 3GPP2. Steps or parts that are not described to clarify the technical features of the present invention can be supported by those documents. Further, all terms as set forth herein can be explained by the standard documents.

Techniques described herein can be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as Universal Terrestrial Radio Access (UTRA) or CDMA2000. TDMA may be implemented as a radio technology such as Global System for Mobile communications (GSM)/General Packet Radio Service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, Evolved-UTRA (E-UTRA) etc. UTRA is a part of Universal Mobile Telecommunication System (UMTS). 3GPP LTE is a part of Evolved UMTS (E-UMTS) using E-UTRA. 3GPP LTE employs OFDMA for downlink and SC-FDMA for uplink. LTE-A is evolved from 3GPP LTE.

For clarity, this application focuses on the 3GPP LTE/LTE-A system. However, the technical features of the present invention are not limited thereto.

### 1. Overview of Device-to-Device (D2D) Communication

D2D communication refers to a method of performing direct communication between UEs without a BS when a channel state between two or more UEs is good or UEs are closely located. Here, D2D communication according to the present invention is distinguished from Bluetooth, infrared communication, etc., which exchanges data between UEs without intervention of a BS, since predetermined control information for D2D communication is provided by the BS although UEs exchange data through direct communication.

In client cooperative communication, UE B assisting other UEs receives data that UE A wants to transmit to a BS and transmits the received data to the BS or receives data that the BS wants to transmit to UE A and delivers the received data to UE A. Here, unidirectional or bidirectional communication is performed between UEs within a system bandwidth. Accordingly, client cooperative communication can be regarded as an example of D2D communication. Client cooperative communication is applicable to uplink transmission through cooperation between UEs and also applicable to downlink transmission through cooperation between a BS and a UE, cooperation between BSs or cooperation between antennas of a distributed antenna system (DAS).

As described above, UE A exchanges data and/or control information with the BS through UE B, in general. However, UE A may directly exchange data and/or control information with the BS as necessary. That is, UE A can directly exchange data with the BS in consideration of channel state between the BS and UE A and channel state between UE A and UE B. Here, the data and/control information directly exchanged between UE A and the BS may be identical to or different from data and/or control information exchanged between UE A and the BS through UE B.

A wireless communication system may simultaneously support D2D communication and client cooperative communication or only one thereof When the wireless communication system simultaneously supports D2D communication and client cooperative communication, messages requesting direct communication and client cooperative communication may be identical to or different from each other.

D2D communication or client cooperative communication can be used interchangeably with D2D communication/M2M (MS-to-MS) communication or P2P (Peer-to-peer) communication. For convenience, D2D communication or client cooperative communication is referred to as ‘D2D communication’ in the following description. In the specification, ‘D2D device’ refers to a UE supporting D2D communication.

### 2. Method for Performing D2D Communication

D2D devices and cellular devices coexist in a cell. Accordingly, to efficiently perform D2D communication, a BS can receive an indicator indicating the type of each device or whether or not D2D communication is supported from each device to check the state of each device. In addition, to allow a D2D device (T_DD: transmission D2D device) that transmits a D2D signal to efficiently search for or select a D2D device (R_DD: reception D2D device) that receives a signal through D2D communication, D2D devices or devices supporting D2D transmission can be grouped to perform D2D transmission between D2D devices in the group or perform D2D transmission to a D2D device belonging to a neighboring group. A description will be given of a method for indicating a D2D device and a method for grouping D2D devices for efficient D2D communication.

### 2.1. Method for Indicating Whether or Not a Device Supports D2D Communication

### 2.1.1. First Embodiment

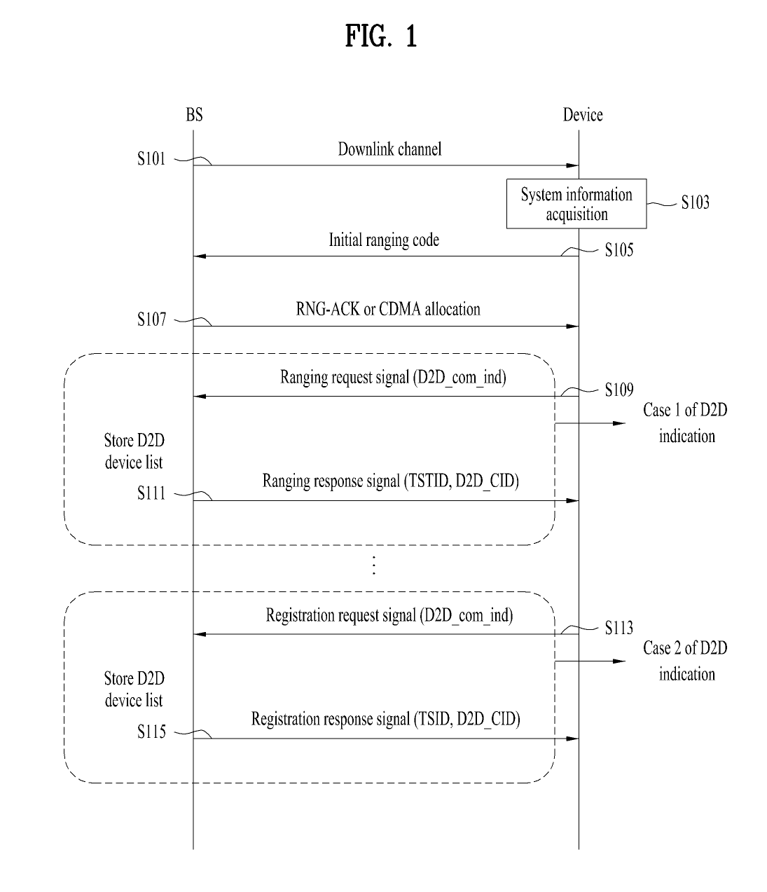

FIG. 1 illustrates a method for indicating whether or not a device supports D2D communication to a BS.

Referring to FIG. 1, when the device is powered on or newly enters a cell, the device performs initial cell search involving synchronization with a BS and receives a downlink channel from the BS (S101) to acquire system information (S103). Then, the device performs initial ranging in such a manner that the device transmits an initial ranging code to the BS (S105) and receives a ranging acknowledgement (RNG-ACK) signal or CDMA allocation signal from the BS as a response to the initial ranging code (S107).

In this manner, the device can transmit indication information representing whether or not the device supports D2D communication to the BS after initial ranging during a network access process. In case 1, the device can transmit the indication information representing whether or not the device supports D2D communication to the BS using a ranging request signal RNG_REQ in step S109. In case 2, the device can transmit the indication information to the BS using a registration request signal REG_REQ used for system access.

Whether or not the device supports D2D communication can be indicated using a 1-bit or 2-bit D2D indicator D2D_Com_ind in the ranging request signal or registration request signal. For example, when whether or not the device supports D2D communication is indicated using the 1-bit D2D indicator D2D_Com_ind, D2D_Com_ind is set to 1 if the device supports D2D communication and set to 0 if not.

Upon reception of the D2D indicator D2D_Com-ind from the device through the ranging request signal or registration request signal, the BS allocates a D2D communication identifier D2D_CID to the device through a ranging response signal RNG_RSP or a registration response signal REG_RSP when D2D_Com_ind is 1, that is, the device supports D2D communication (S111 and S115). Upon reception of the D2D communication identifier, the D2D device stores the D2D communication identifier all the time irrespective of transmission mode.

The D2D communication identifier D2D_CID allocated by the BS to the D2D device may be returned or reallocated by the BS in the following cases.

1) Case in which the D2D device is out of the coverage of a cell managed by the BS that allocates D2D_CID or the D2D device cannot directly or indirectly exchange control information with the BS for various reasons.

2) Case in which the D2D device allocated D2D_CID is powered off

3) Case in which the D2D device allocated D2D_CID hands over to a cell managed by another BS.

4) Case in which the D2D device needs to belong to a new group since the D2D device is not suitable for the current group.

During network entry or reentry of the device, the BS can determine whether or not the device supports D2D communication using the signal received from the device and store information about devices supporting D2D communication in the form of a table or bitmap. The information (table or bitmap) about the D2D devices, stored by the BS, can be periodically updated. The table or bitmap is configured using D2D communication identifiers of the devices and may additionally include station identifiers (STIDs). Here, the BS can transmit, to the corresponding D2D device, a temporary station identifier (TSTID) allocated to the D2D device along with the ranging response signal delivered to the D2D device in step S111 or the registration response signal delivered to the D2D device in step S115.

Upon reception of the D2D indicator D2D_Com-ind from the D2D device through the ranging request signal in step S109 or the registration request signal in step S113, the BS may not allocate a new ID, that is, the D2D communication identifier D2D_CID to the D2D device. In this case, the BS can generate and store a list (in the form of a table or bitmap) of D2D devices using information (TSTIDs, temporary cell-radio network temporary identifiers (TC-RNTIs), STIDs, cell-radio network temporary identifiers (C-RNTIs), media access control addresses (NAC-address), etc.) on D2D devices that have transmitted D2D CID to the BS. When the BS generates the list using temporary identifiers, the BS can update the list using IDs or MAC-addresses allocated to D2D devices. When the BS uses the identifier or MAC-address allocated to the D2D device in this manner, the BS need not newly assign a D2D communication identifier to the D2D device through the ranging response signal in step S111 or registration response signal in step S115 and thus system overhead can be reduced.

The BS can confirm location information on D2D devices using feedback information or location based signals (LBSs) from the D2D devices during data transmission between the BS and the D2D devices using information on the D2D devices stored in the table or bitmap. Here, the feedback information received from the D2D devices can include channel quality information, pathloss information, geometry information, signal-to-interference plus noise ratio (SINR), interference level, modulation and coding scheme (MCS), information regarding multiple input multiple output (MIMO), precoding matrix indicator (PMI), channel gain, etc. Upon acquisition of the location information on the D2D devices using the feedback information or LBSs from the D2D devices, the BS group D2D devices in the cell using the location information. A method of grouping D2D devices will be described below in detail.

### 2.1.2. Second Embodiment

Distinguished from the first embodiment, the indication information representing whether or not the device in the cell supports D2D communication can indicate whether or not the device supports D2D communication through signaling after the device accesses or links to the BS.

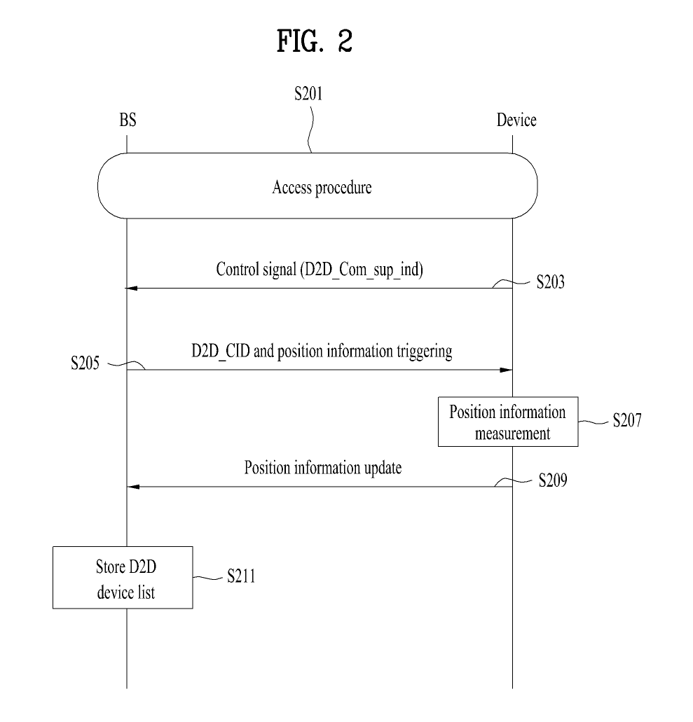

FIG. 2 illustrates a method for indicating whether or not the device supports D2D communication to the BS.

Referring to FIG. 2, upon completion of connection to the BS (S201), the D2D device can signal D2D indication to the BS before entering an idle mode or sleep mode (S203). Specifically, when the D2D device connected to the network changes from a mode in which the D2D device performs transmission to the BS, that is, a connected mode to the idle mode or sleep mode, the D2D device can inform the BS that the D2D device can perform D2D communication by indicating the type thereof using a control signal or by transmitting a D2D support indicator D2D_Com_sup_ind indicating whether D2D communication is supported or not to the BS before mode change or end of the connected mode.

Upon reception of the control signal including the D2D support indicator, the BS allocates the D2D communication identifier D2D CID to the D2D device for D2D communication (S205). Here, the BS can transmit a trigger indicator with respect to transmission of the location or positioning information of the D2D device and information on a location or positioning information transmission period along with the D2D communication identifier.

Upon reception of the D2D communication identifier and trigger identifier with respect to transmission of the location or positioning information of the D2D device, the D2D device measures the location or positioning information thereof in order to signal the same to the BS before the connected mode is changed (S207) and transmits location update information to the BS based on the measured information (S209). Here, the location update information transmitted to the BS from the D2D device can include channel quality, power, pathloss, geometry information, SINR, interference level, MCS, MIMO information, PMI, channel gain, etc. based on signals received from the BS.

Upon reception of the location update information from the D2D device, the BS generates and stores a list of D2D devices in the form of a table or bitmap using the received information and D2D communication identifier allocated to the D2D device (S211).

Upon reception of the D2D support identifier D2D_Com_sup_ind from the D2D device through the control information in step S203, the BS may not allocate the D2D communication identifier D2D CID to the D2D device that has transmitted the control signal and may generate and store a list (in the form of a table or bitmap) of D2D devices performing D2D communication using information (STIDs, C-RNTIs, MAC-addresses, IP (Internet protocol) addresses, etc.) of the D2D devices. That is, a D2D list is generated using information about devices that have transmitted the D2D support indicator such that D2D devices can perform D2D communication using information included in the list, thereby reducing overhead of signaling to the D2D devices.

### 2.1.3. Third Embodiment

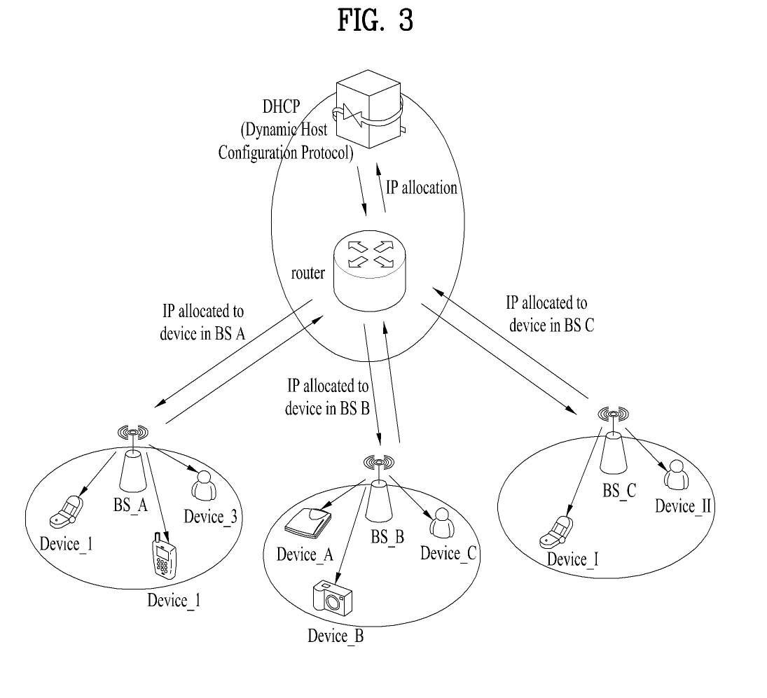

FIG. 3 illustrates allocation of an IP address to a device according to an embodiment of the present invention.

Referring to FIG. 3, when D2D devices are connected to the BS, the BS transmits indication information about the D2D devices to a higher layer (gateway or core network). Upon reception of the indication information about the D2D device from the BS, the higher layer (e.g. dynamic host configuration protocol (DHCP) included in a higher network) allocates IP addresses to the corresponding devices using an IP pool composed of IPs that are not used in the network. The allocated IP addresses are transmitted to the BS connected to the devices through signaling. The BS delivers the allocated IP addresses to the devices. The IP addresses allocated to the devices may be cellular IP addresses or mobile IP addresses in consideration of mobility of the devices. The IP addresses are rarely returned or allocated according to device mode since they have a longer lift time than the identifier allocated by the BS, and thus the IP addresses can be allocated to the devices and used for a long time.

Upon allocation of the IP addresses from the BS, the devices can transmit the allocated IP addresses to the BS when delivering the D2D communication indicator D2D_Com_ind or D2D support indicator D2D_Com_sup_ind in the above-described first and second embodiments.

Upon reception of the IP addresses along with the D2D communication indicator or D2D support indicator from the devices, the BS can generate a list (in the form of a table or bitmap) of D2D devices based on the received IP addresses and store the list. In addition, the BS can transmit the generated list for D2D communication to the devices through unicast or multicast signaling. The list of IP addresses of D2D devices, generated by the BS, can be shared with other BSs through a backbone or X2 interface.

### 2.2. Method for Performing D2D Communication Using D2D Device Grouping

While embodiments for D2D communication initiation are described based on D2D communication between two devices for convenience in the following, the embodiments are equally applicable to D2D communication between a single device and multiple devices.

D2D devices and a BS can perform D2D communication using one of the following methods or a combination of two or more methods.

### 2.2.1. First Embodiment for Performing D2D Communication

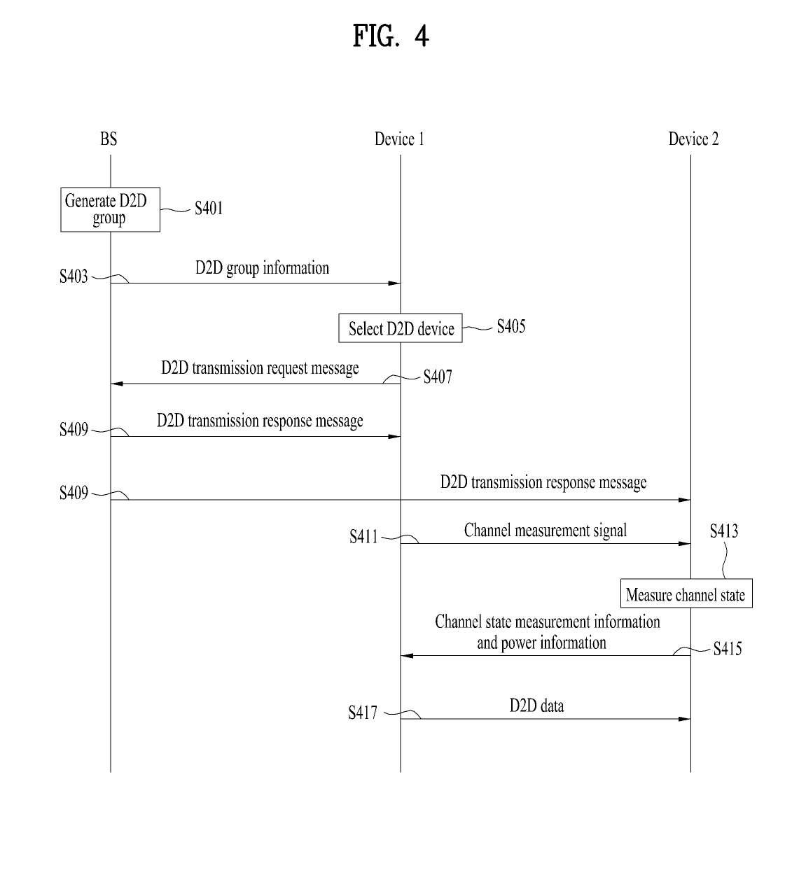

FIG. 4 illustrates a method for performing D2D communication according to an embodiment of the present invention.

Referring to FIG. 4, the BS, which has stored the list of information on D2D devices through the above-described methods according to the first, second and third embodiments, generates D2D groups using the information on the D2D devices (S401).

To generate the D2D device groups, the BS can use mobility information and location information transmitted from the D2D devices. Here, the BS can detect the positions of the D2D devices using feedback information from the D2D devices, for example, channel quality, power, pathlosses, geometry information, SINRs, interference levels, MCSs, MIMO information, PMIs, channel gains, etc. during data transmission between the BS and the D2D devices. In addition, the BS can detect the locations of the D2D devices using LBS information. The mobility information transmitted from the D2D devices can be classified according to a predetermined ratio (e.g. slot, medium, fast) and may include moving speed information of the D2D devices.

For example, the BS can determine D2D device grouping according to mobility and pathloss levels of the D2D devices. Here, the pathloss levels for D2D device grouping can be determined by classifying pathlosses of the D2D devices according to a predetermined ratio or through quantization of each pathloss. The predetermined ratio or a quantization level with respect to pathlosses for grouping can be a fixed value or variable value.

The BS can perform more definite grouping using position information transmitted along with the above-described information from the devices. For example, when grouping is performed only using pathlosses, devices having pathlosses may be located opposite to each other or spaced apart from each other on the basis of the BS. In this case, the devices may have difficulty performing D2D communication due to transmit power, interference, etc. caused by the distance therebetween even though the devices belong to the same group. To overcome this problem, the BS can group D2D devices, which are primarily classified through pathlosses using the location or positioning information thereof, using geometry information. That is, devices may belong to different groups according to positions thereof even if the devices have similar pathlosses. According to the above-described method, D2D communication reliability of D2D devices in the same group can be improved.

When the BS groups devices supporting D2D communication as described above, a maximum group size can be predetermined such that the size of each group does not exceed the predetermined maximum size. Here, if many D2D devices are located close to a corresponding D2D device and thus the size of the corresponding group exceeds the maximum size, the D2D devices can be grouped into multiple groups.

In addition, to reduce the quantity of information on D2D groups, transmitted from the BS to the corresponding D2D devices, the information on D2D groups can be included in the D2D communication identifier D2D CID transmitted to the D2D devices in step S111, S115 or S205. For example, if the maximum D2D group size is 16 and the D2D communication identifier is represented as a hexadecimal, the D2D communication identifier can be set by allocating a D2D group identifier to the first symbol of two hexadecimal symbols and allocating a D2D device identifier in the D2D group to the second symbol in such that manner that 0-th D2D group is allocated to 00 to 0F and first D2D group is allocated to 10 to 1F. In this case, D2D group information may not include information indicating the D2D group identifier in step S403.

Upon generation of the D2D groups, the BS transmits the D2D group information D2D_Group_info to D2D devices in the cells (S403). Here, the D2D group information can be transmitted to each D2D device as a broadcast, multicast or unicast signal.

The D2D group information transmitted from the BS includes the following information.

1) The number of groups

2) The number of members of a group

3) D2D group identifier/indicator

4) List of D2D device identifiers or D2D communication identifiers of members of a group (device ID/D2D_CID)

5) D2D device mode or state (idle mode, sleep mode or active mode)

6) Grouping period/cycle

When the D2D group information is transmitted to each D2D device through the unicast signal, the BS can transmit information on a group to which a corresponding D2D device belongs to the D2D device and also transmit information Neighbor_group_info on a neighboring group of the D2D device to the D2D device. In this case, the information on the neighbor group can be configured similarly to the D2D group information.

In addition, the D2D group information may be transmitted to each D2D device by the BS through the unicast signal after the BS receives a D2D communication triggering signal, indication signal or request signal from the corresponding D2D device.

The D2D device (device 1) that has received the D2D group information from the BS can be aware of the information on the D2D devices in the cell and information on neighboring D2D devices. The transmission device (device 1) that attempts to perform D2D communication selects a reception device (device 2) using this information (S405) and transmits a D2D transmission request message to the BS (S407). In this manner, the D2D device in the cell can be aware of the information on the D2D group corresponding thereto using the received D2D group information and discover information on D2D devices belonging to another group or a neighboring group without additional signal transmission/reception between D2D devices.

The D2D transmission request message transmitted from the transmission D2D device (Tx D2D device, device 1) to the BS includes the following information.

1) Reception D2D device information (Rx D2D device info)

2) Group identifier

Here, the group identifier indicates the transmission D2D device when the transmission D2D device and the reception D2D device belong to different groups and can be set to null or zero when both belong to the same group.

3) D2D communication identification

4) Device identifier (STID, C-RNTI or MAC address) or D2D communication identifier (D2D_CID)

5) Bandwidth request information for D2D communication

Upon reception of the D2D transmission request message from the D2D device, the BS delivers a D2D transmission response message to the transmission D2D device (device 1) that has transmitted the D2D transmission request message and the reception D2D device (device 2) to which D2D transmission will be performed (S409).

The D2D transmission response message transmitted from the BS to the transmission D2D device (device 1) and the reception D2D device (device 2) includes the following information.

1) Resource allocation information

The resource allocation information represents information on subframes or resource blocks allocated for D2D transmission between the transmission D2D device (device 1) and the reception D2D device (device 2).

2) Transmit power control information

3) Signal boosting information

4) D2D operation indicator

5) Device identifiers (STIDs, C-RNTIs or MAC Addresses) or D2D communication identifiers (D2D_CID) of the transmission D2D device (device 1) and the reception D2D device (device 2)

6) Threshold

The threshold represents information that can be a reference point for change to a D2D transmission mode and can include SINR, channel quality information (CQI), interference level, channel quality, etc.

Upon reception of the D2D transmission response message, the transmission D2D device (device 1) transmits a channel measurement signal to the reception D2D device (device 2) using resources allocated thereto by the BS to measure a channel state between the transmission D2D device and the reception D2D device (S411). Here, a pilot signal, a sounding reference signal (SRS), a channel state information reference signal (CSI-RS), a demodulation reference signal (DM-RS) or a pseudo random sequence can be used as the channel measurement signal.

Upon reception of the D2D transmission response message from the BS in step S409, the reception D2D device (device 2) monitors resources allocated thereto by the BS in order to receive the channel measurement signal transmitted from the transmission D2D device (device 1). The reception D2D device measures the channel state between the two devices using the channel measurement signal upon reception of the channel measurement signal from the transmission D2D device (device 1) through monitoring of the allocated resources (S413).

Here, the reception D2D device (device 2) can set a power level for the link between the two devices through the power of the channel measurement signal received from the transmission D2D device (device 1) using the transmit power control information on the signal transmitted from the transmission D2D device (device 1), which is received from the BS in step S409. That is, a minimum transmit power value satisfying the receive power of the reception D2D device (device 2) can be set for D2D communication between the two devices (device 1 and device 2).

Upon measurement of the channel state between the transmission D2D device (device 1) and the reception D2D device (device 2), the reception D2D device transmits channel state measurement information (e.g. SINR, CQI, CSI, interference level, etc.) and power information to the transmission D2D device (device 1) (s415). Here, the power information can correspond to information on the power of the channel measurement signal received from the transmission D2D device (device 1) in step S411 or the minimum transmit power value set by the reception D2D device (device 2) in step S413.

Upon reception of the channel state measurement information and power information from the reception D2D device (device 2), the transmission D2D device (device 1) can detect the channel state between the two devices and control transmit power for D2D transmission. The transmission D2D device (device 1) transmits D2D data to the reception D2D device (device 2) using the information included in the D2D transmission response message received from the BS in step S409.

### 2.2.2. Second Embodiment for Performing D2D Communication

D2D transmission between the transmission D2D device (device 1) and the reception D2D device (device 2) can be initiated by determining whether or not the current mode is changed to the D2D communication mode by the reception D2D device (device 2).

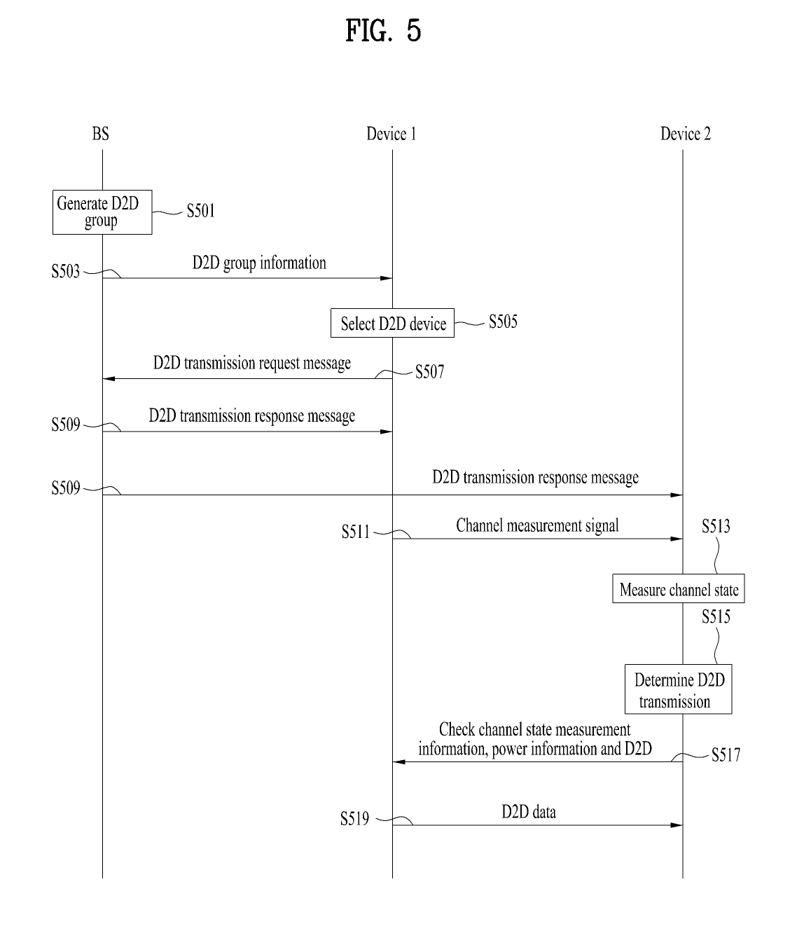

FIG. 5 illustrates a method for performing D2D communication according to an embodiment of the present invention. Steps S501 to S513 correspond to steps S401 to S413 illustrated in FIG. 4 and thus description thereof is omitted.

Referring to FIG. 5, upon measurement of the channel state between the transmission D2D device (device 1) and the reception D2D device (device 2) using the channel measurement signal transmitted from the transmission D2D device (device 1) in step S513, the reception D2D device (device 2) determines whether or not to perform D2D communication by comparing the channel state measurement information (e.g. SINR, CQI, CSI, interference level, etc.) with the threshold for determining D2D communication, received from the BS in step S509 (S515). For example, when the reception D2D device (device 2) compares the SINR as the channel state measurement information with the threshold, the reception D2D device performs D2D communication if the SINR exceeds the threshold and does not perform D2D communication if the SINR is lower than the threshold.

When the reception D2D device (device 2) determines that D2D communication is performed in step S515, the reception D2D device (device 2) transmits the channel state measurement information (e.g. SINR, CQI, CSI, interference level, etc.) and power information to the transmission D2D device (device 1) (S517). Here, the reception D2D device (device 2) can add D2D transmission acknowledgement (initiation indicator) information to the channel state measurement information and power information and transmit the same to explicitly signal determination of D2D communication to the transmission D2D device (device 1). In addition, the reception D2D device (device 2) may implicitly signal determination of D2D communication to the transmission D2D device (device 1) by transmitting the channel state information and power information. In FIG. 5, it is assumed that the reception D2D device (device 2) transmits the D2D transmission acknowledgement (initiation indicator) information along with the channel state measurement information and power information. The power information can correspond to information on the power of the channel measurement signal received from the transmission D2D device (device 1) in step S511 or the minimum transmit power value set by the reception D2D device (device 2) in step S513.

When the reception D2D device (device 2) determines that D2D communication is not performed in step S515, the reception D2D device (device 2) can transmit a message (e.g. NACK message) including information representing that D2D communication is not performed to the transmission D2D device (device 1).

Upon reception of the channel state measurement information, power information and D2D transmission acknowledgement (initiation indicator) information from the reception D2D device (device 2), the transmission D2D device (device 1) transmits D2D data to the reception D2D device (device 2) using the information included in the D2D transmission response message received from the BS in step S509 (step S519).

### 2.2.3. Third Embodiment For Performing D2D Communication

D2D transmission between the transmission D2D device (device 1) and the reception D2D device (device 2) can be initiated by determining whether or not the current mode is changed to the D2D communication mode by the transmission D2D device (device 1).

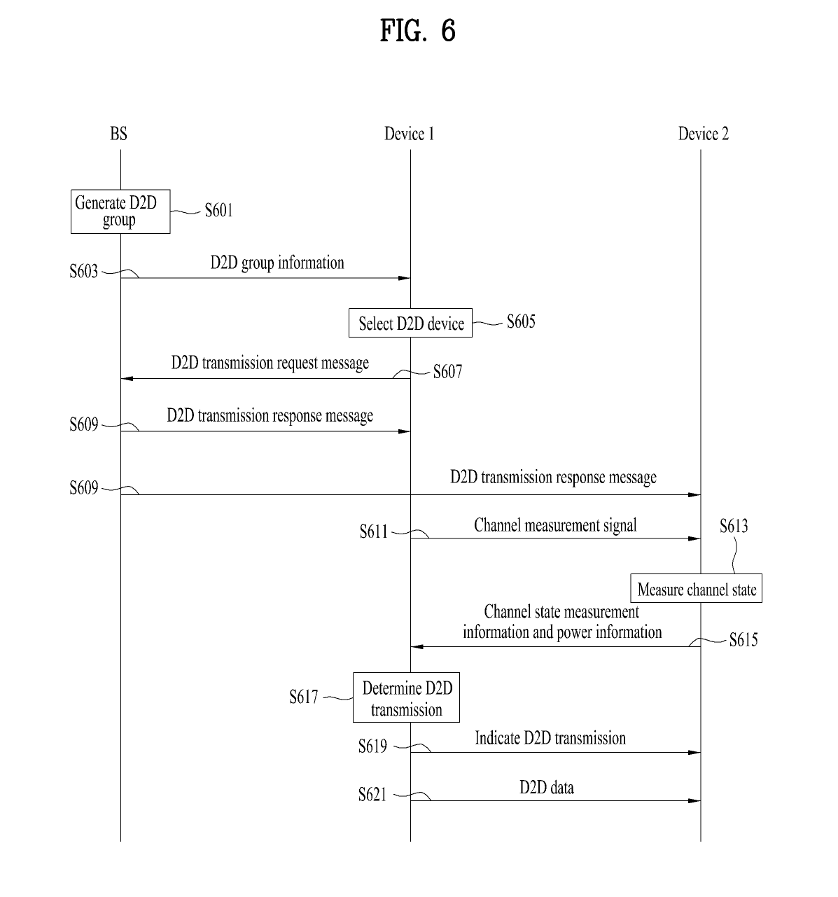

FIG. 6 illustrates a method for performing D2D communication according to an embodiment of the present invention. Steps S601 to S615 correspond to steps S401 to S415 illustrated in FIG. 4 and thus description thereof is omitted.

Referring to FIG. 6, upon reception of the channel state measurement information (e.g. SINR, CQI, CSI, interference level, etc.) and power information from the reception D2D device (device 2) in step S615, the transmission D2D device (device 1) determines whether or not to perform D2D communication by comparing the received information with the threshold for determining D2D communication, received from the BS in step S609 (S617). Here, when the transmission D2D device (device 1) compares the SINR as the channel state measurement information with the threshold, the transmission D2D device (device 1) performs D2D communication if the SINR exceeds the threshold and may not perform D2D communication if the SINR is lower than the threshold.

When the transmission D2D device (device 1) determines that D2D communication is performed in step S617, the transmission D2D device (device 1) transmits a message indicating D2D communication to the reception D2D device (device 2) (S619). The D2D communication indication message can include D2D communication initiation information, transmit power, time offset information, etc.

When the transmission D2D device (device 1) determines that D2D communication is not performed in step S617, the transmission D2D device (device 1) can transmit a message (e.g. NACK message) including information representing that D2D communication is not performed to the reception D2D device (device 2).

Upon transmission of the D2D communication indication message, the transmission D2D device (device 1) transmits D2D data to the reception D2D device (device 2) using the information included in the D2D transmission response message received from the BS in step S409 (S621).

### 2.2.4. Fourth Embodiment for Performing D2D Communication

The transmission D2D device (device 1) may not initiate D2D communication with the reception D2D device (device 2). In this case, the transmission D2D device (device 1) can initiate D2D communication with another D2D device.

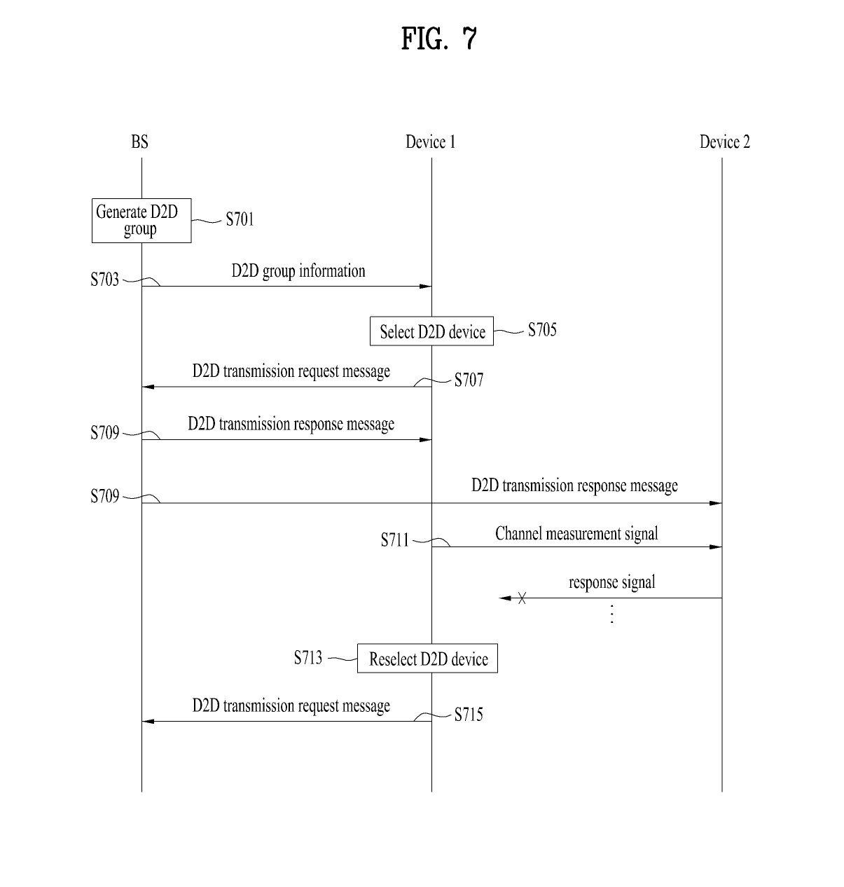

FIG. 7 illustrates a method for performing D2D communication according to an embodiment of the present invention. Steps S701 to S709 correspond to steps S401 to S409 illustrated in FIG. 4 and thus description thereof is omitted.

Referring to FIG. 7, the transmission D2D device (device 1), which has received the D2D transmission response message, transmits the channel measurement signal to the reception D2D device (device 2) using the resources allocated thereto by the BS in order to measure the channel state between the two devices (S711). Here, if the transmission D2D device (device 1) does not receive a response signal to the channel measurement signal from the reception D2D device (device 2), the transmission D2D device (device 1) retransmits the channel measurement signal to the reception D2D device (device 2). That is, the transmission D2D device (device 1) retransmits the channel measurement signal for link measurement to the reception D2D device (device 2) when the transmission D2D device (device 1) does not receive a response signal including the channel state measurement information (e.g. SINR, CQI, CSI, interference level, etc.) or power information from the reception D2D device (device 2) for a predetermined time.

The number (e.g. 2 or 3) of retransmissions of the channel measurement signal of the transmission D2D device (device 1) can be predetermined In this case, the transmission D2D device (device 1) retransmits the channel measurement signal by the predetermined number of retransmissions. If the transmission D2D device (device 1) does not receive a feedback signal or the channel state measurement information from the reception D2D device even through retransmission or does not receive the feedback signal or channel state measurement information from the reception D2D device until a predetermined timer expires, the transmission D2D device (device 1) reselects another reception D2D device with which D2D communication will be performed using the D2D group information received in step S703 and transmits the D2D transmission request message to the BS (S715). Then, the steps following S709 are repeated.

### 2.2.5. Fifth Embodiment for Performing D2D Communication

When the transmission D2D device (device 1) cannot initiate D2D communication with the reception D2D device (device 2) as described above, the transmission D2D device (device 1) can initiate D2D communication with another D2D device.

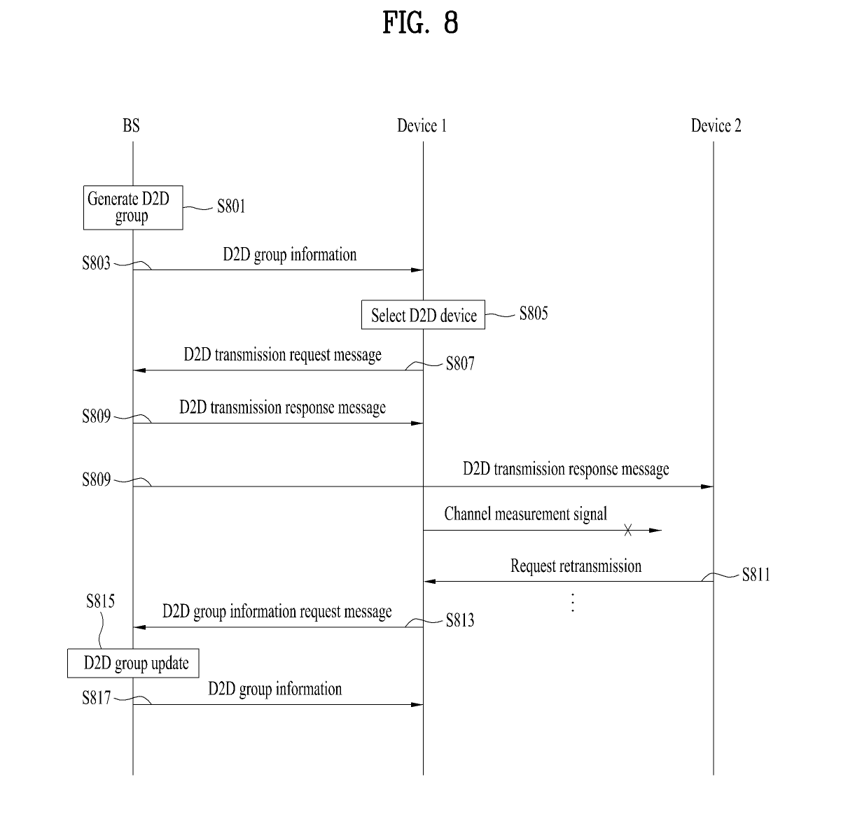

FIG. 8 illustrates a method for performing D2D communication according to an embodiment of the present invention. Steps S801 to S809 correspond to steps S401 to S409 illustrated in FIG. 4 and thus description thereof is omitted.

Referring to FIG. 8, upon reception of the D2D transmission response message from the BS, the reception D2D device (device 2) monitors resources allocated thereto by the BS in order to receive the channel measurement signal transmitted from the transmission D2D device (device 1). Here, if the reception D2D device (device 2) does not receive the channel measurement signal from the transmission D2D device (device 1) until a predetermined timer expires, the reception D2D device (device 2) transmits a message (or NACK signal) requesting/indicating retransmission of the channel measurement signal to the transmission D2D device (device 1) (S811). In this case, the reception D2D device (device 2) can deliver transmit power boosting information along with the retransmission request message to the transmission D2D device (device 1) since the reception D2D device (device 2) can be aware of the transmit power of the transmission D2D device (device 1) through the D2D transmission response message received from the BS in step S809.

Upon reception of the retransmission request message (or NACK signal) from the reception D2D device (device 2), the transmission D2D device (device 1) retransmits the channel measurement signal to the reception D2D device (device 2) using the received power boosting information. If the reception D2D device (device 2) cannot receive the channel measurement signal even through this procedure, the transmission D2D device (device 1) performs a predetermined number of retransmissions of the channel measurement signal. The number of retransmissions of the channel measurement signal of the transmission D2D device (device 1) can be predetermined. In this case, the transmission D2D device (device 1) retransmits the channel measurement signal by the predetermined number of retransmissions. When the transmission D2D device (device 1) receives the retransmission request message (or NACK signal) from the reception D2D device (device 2) even upon the predetermined number of retransmissions, the transmission D2D device (device 1) transmits a message (or D2D group update request message) requesting the D2D group information to the BS (S813). Here, the transmission D2D device (device 1) can explicitly inform the BS that D2D communication with the reception D2D device (device 2) has failed by transmitting a D2D failure message to the BS. In addition, the transmission D2D device (device 1) may implicitly inform the BS that D2D communication has failed by transmitting the D2D group information request message to the BS. In FIG. 8, it is assumed that the transmission D2D device (device 1) transmits only the D2D group information request message to the BS.

Upon reception of the D2D group information request message from the transmission D2D device (device 1), the BS updates the list of D2D devices or group information on the D2D devices (S815). That is, the BS can update the list of the D2D devices using indication information representing whether or not D2D communication is supported, received from the D2D devices. In addition, the BS regroups D2D devices using mobility information, geometry information or positioning information of devices supporting D2D communication.

The BS transmits the updated D2D group information to the transmission D2D device (device 1) (S817). Here, the BS may retransmit the D2D group information generated in step S801. In this case, step S815 can be omitted. Subsequently, the steps following S805 are repeated.

When the transmission D2D device (device 1) receives the retransmission request message (or NACK signal) from the reception D2D device (device 2) even upon the predetermined number of retransmissions or transmission of the channel measurement signal for a predetermined time, the transmission D2D device (device 1) can re-request the BS to provide a channel or resources through which signals are transmitted/received between the two D2D devices. At the request of the transmission D2D device (device 1) for the channel or resources for signal transmission, the BS transmits allocation resource information, channel measurement signal (pilot signal or reference signal) information, transmit power information, etc. to the transmission D2D device (device 1) and the reception D2D device (device 2) through step S809. Upon reception of the information from the BS, the transmission D2D device (device 1) checks the channel state using the received information and performs D2D communication. When the reception D2D device (device 2) does not receive the channel measurement signal transmitted from the transmission D2D device (device 1), the reception D2D device can transmit a channel or resource request signal to the BS, as described above, to repeat the steps following S809 or the steps following S813.

### 2.2.6. Sixth Embodiment for Performing D2D Communication

Distinguished from the above-described embodiments, the list of D2D devices or information on D2D device groups can be generated at the request of a D2D device that performs D2D communication or attempts to perform D2D communication.

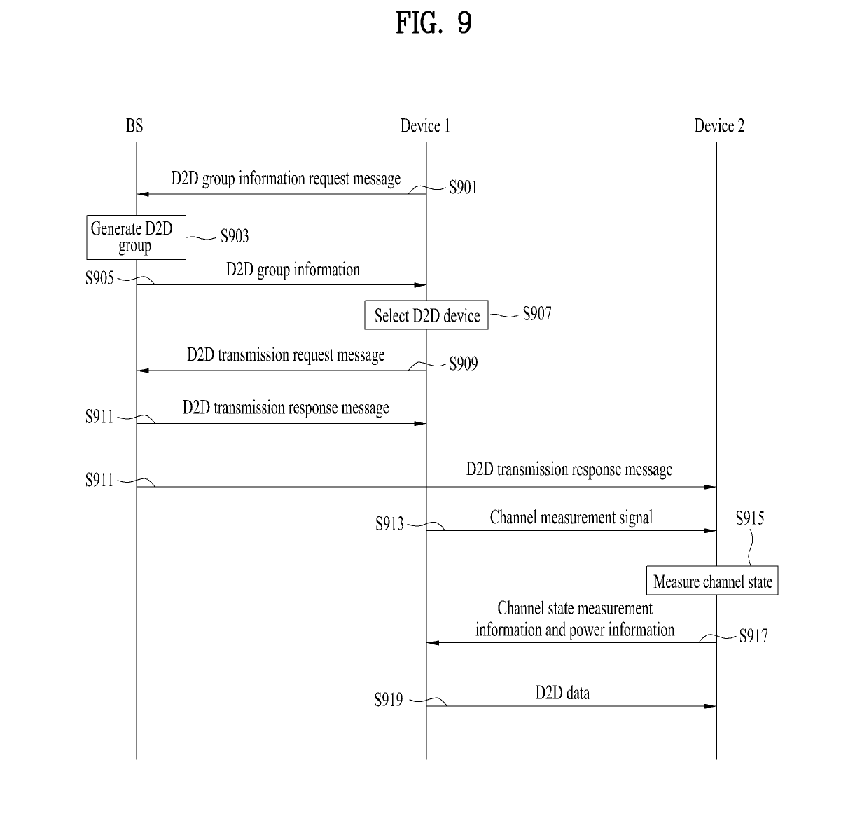

FIG. 9 illustrates a method for performing D2D communication according to an embodiment of the present invention.

Referring to FIG. 9, the transmission D2D device (device 1) that attempts to perform D2D communication transmits a D2D group information request message to the BS in order to initiate D2D communication (S901).

Upon reception of the D2D group information request message from the transmission D2D device (device 1), the BS generates D2D group information about the transmission D2D device (device 1) (S903). The BS that stores information (device type, whether or not D2D communication is supported, etc.) about D2D devices in the cell can group D2D devices adjacent to the transmission D2D device (device 1) or group D2D devices capable of performing D2D communication upon reception of the D2D group information request message from the transmission D2D device (device 1). That is, the BS can generate only a group corresponding to a device that transmits a D2D communication request message according to the message rather than generating groups of all D2D devices present in the cell.

Upon generation of the D2D group information about the transmission D2D device (device 1) that has transmitted the D2D group information request message, the BS transmits the D2D group information to the transmission D2D device (device 1) (S905). Steps S907 to S919 correspond to step S405 to S417 illustrated in FIG. 4 and thus description thereof is omitted. The present embodiment can be combined with the embodiment illustrated in FIG. 8. That is, D2D communication can be determined using the threshold received by the transmission D2D device (device 1) or the reception D2D device (device 2) from the BS and the transmission D2D device (device 1) can initiate D2D communication with another D2D device when the transmission D2D device (device 1) does not receive a response message from the reception D2D device (device 2) upon a predetermined number of retransmission or for a predetermined time or receives the retransmission request message from the reception D2D device (device 2).

### 3. Devices to Which the Present Invention is Applicable

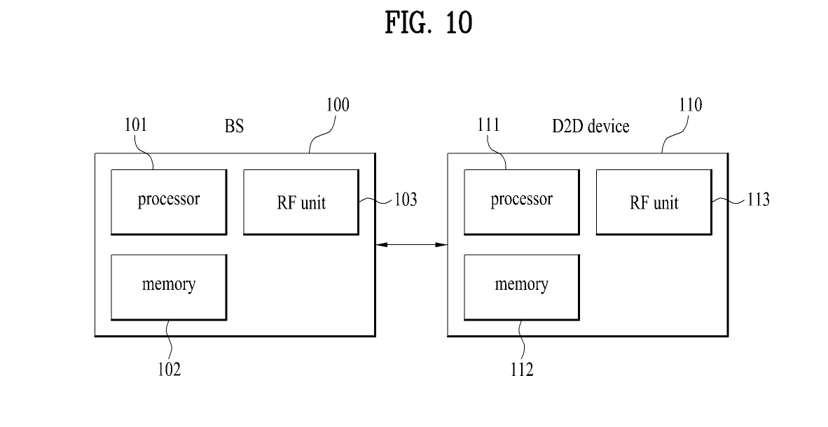

FIG. 10 is a block diagram of a wireless communication system according to an embodiment of the present invention.

Referring to FIG. 10, the wireless communication system includes a BS 100 and a plurality of D2D devices 110 located in the coverage of the BS 100.

The BS includes a processor 101, a memory 102 and a radio frequency (RF) unit 102. The processor 101 may be configured to implement the procedures and/or methods proposed by the present invention. Radio interface protocol layers can be implemented by the processor 101. The memory 102 is connected to the processor 101 and stores information related to operations of the processor 101. The RF unit 103 is connected to the processor 101 and transmits and/or receives an RF signal.

The D2D device 110 includes a processor 111, a memory 112 and an RF unit 113. The processor 111 may be configured to implement the procedures and/or methods proposed by the present invention. Radio interface protocol layers can be implemented by the processor 111. The memory 112 is connected to the processor 111 and stores information related to operations of the processor 111. The RF unit 113 is connected to the processor 111 and transmits and/or receives an RF signal.

The memories 102 and 112 may be located inside or outside the processors 101 and 111 and connected to the processors 101 and 111 through known various means. The BS 100 and/or D2D device 110 may include a single antenna or multiple antennas.

The embodiments of the present invention described hereinbelow are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present invention or included as a new claim by a subsequent amendment after the application is filed.

The embodiments of the present invention may be achieved by various means, for example, hardware, firmware, software, or a combination thereof In a hardware configuration, the methods according to the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. For example, software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

Data transmission/reception methods in a wireless access system according to the present invention are applicable to 3GPP LTE/LTE-A or IEEE 802 and various other wireless access systems.

1. A method for performing communication between devices in a wireless access system supporting device-to-device communication (D2D), the method comprising:
transmitting, by a first device to a base station (BS), information indicating whether or not the first device supports D2D communication;
receiving, by the first device from the BS, group information on grouping of devices supporting D2D communication using mobility information and position information on the devices;
selecting, by the first device, a second device attempting to perform D2D communication using the group information; and
performing D2D, by the first device, communication with the selected second device.

2. The method according to claim 1, wherein the first device is configured to transmit the indication information during a network access process.

3. The method according to claim 1, wherein the first device is configured to transmit the indication information before mode change to an idle mode or a sleep mode.

4. The method according to claim 1, wherein the first device is configured to transmit an Internet protocol (IP) addresses allocated thereto along with the indication information.

5. The method according to claim 1, further comprising:
transmitting, by the first device to the second device, a measurement signal for measuring a channel state between the first device and the second device;
receiving, by the first device from the second device, channel state information obtained by measuring the channel state using the measurement signal; and
determining by the first device, whether to perform D2D communication with the second device on the basis of the channel state information.

6. The method according to claim 5, further comprising:
retransmitting, by the first device, the measurement signal to the second device when the first device does not receive the channel state information from the second device within a predetermined time or receives a message requesting retransmission of the measurement signal from the second device.

7. The method according to claim 6, further comprising:
reselecting, by the first device, a device attempting to perform D2D communication using the group information when the first device repeats retransmission of the measurement signal a predetermined number of times or more.

8. The method according to claim 6, further comprising:
transmitting, by the first device, a message requesting update of the group information to the BS when the first device repeats retransmission of the measurement signal a predetermined number of times or more.

9. A device for performing communication between devices in a wireless access system supporting D2D, the device comprising:
a radio frequency (RF) unit for transmitting/receiving a radio signal; and
a processor is configured to transmit, to a BS, information indicating whether or not the device supports D2D communication, to receive, from the BS, group information on grouping of devices supporting D2D communication using mobility information and position information on the devices, to select a second device attempting to perform D2D communication using the group information and to perform D2D communication with the selected second device.

10. The device according to claim 9, wherein the processor is configured to transmit the indication information during a network access process.

11. The device according to claim 9, wherein the processor is configured to transmit the indication information before mode change to an idle mode or a sleep mode.

12. The device according to claim 9, wherein the processor is further configured to transmit an IP addresses allocated to the device along with the indication information.

13. The processor according to claim 9, wherein the processor is further configured to transmit, to the second device, a measurement signal for measuring a channel state between the devices, receive, from the second device, channel state information obtained by measuring the channel state using the measurement signal and determine whether to perform D2D communication with the second device on the basis of the channel state information.

14. The device according to claim 13, wherein the processor is further configured to retransmit the measurement signal to the second device when the channel state information is not received from the second device within a predetermined time or a message requesting retransmission of the measurement signal is received from the second device.

15. The device according to claim 14, wherein the processor is configured to reselect a device attempting to perform D2D communication using the group information when retransmission of the measurement signal is repeated a predetermined number of times or more.

16. The device according to claim 14, wherein the processor is configured to transmit a message requesting update of the group information to the BS when retransmission of the measurement signal is repeated a predetermined number of times or more.
